(19) United States
(12) Patent Application Publication
(10) Pub. No.: US 2013/0029068 A1
(43) Pub. Date: Jan. 31, 2013

(54) EXTRUSION BLOW MOLDED ARTICLES

(71) Applicants: Mark Allan Treece, Jonesborough, TN (US); Thomas Joseph Pecorini, Kingsport, TN (US); Roger Lee Martin, Gray, TN (US); Bryan Steven Bishop, Kingsport, TN (US)

(72) Inventors: Mark Allan Treece, Jonesborough, TN (US); Thomas Joseph Pecorini, Kingsport, TN (US); Roger Lee Martin, Gray, TN (US); Bryan Steven Bishop, Kingsport, TN (US)

(73) Assignee: EASTMAN CHEMICAL COMPANY, Kingsport, TN (US)

(21) Appl. No.: 13/192,978

(22) Filed: Jul. 28, 2011

(51) Int. Cl. B32B 1/08; C08L 67/02; B29C 49/04; C08G 63/183

(52) U.S. Cl. 428/35.7; 528/308.1; 524/605; 264/540

(57) ABSTRACT

Extrusion blow molded (EBM) articles comprising a polyester having a dicarboxylic acid component and a glycol component. The dicarboxlyic acid component comprises at least 90 mole % terephthalic acid residues. The glycol component comprises at least 88 mole % ethylene glycol residues and 7 to 12 mole % residues of a difunctional glycol such as, for example, 1,4-cyclohexanedimethanol. Such EBM articles can exhibit reduced haze, reduced sharkskin, and/or increased compatibility in PET recycling.

### FIELD OF THE INVENTION

The present invention generally relates to polyester compositions made from terephthalic acid, or an ester thereof, or mixtures thereof, and 88 to 93 mole % ethylene glycol that have been found to be particularly useful for extrusion blow molding and/or profile extrusion while having improved compatibility with Post Consumer Recycle (PCR) Polyethylene Terephthalate (PET) streams.

### BACKGROUND OF THE INVENTION

Consumers value the ability to see the contents of their packages. Consumers also appreciate the toughness and gloss of containers made from polyester. Because of this combination of attributes, containers made from polyethylene terephthalate (PET) produced by the injection stretch blow molding process (ISBM) are the most common type of transparent container on the market. However, the ISBM process is limited to uniform shapes and cannot produce bottles that contain a through-handle. Handles are desirable in larger bottle sizes, where gripping a round or square container becomes cumbersome. Larger size bottles containing a through-handle are believed to be produced only by the extrusion blow molding (EBM) process.

A typical extrusion blow molding manufacturing process involves: 1) melting the resin in an extruder; 2) extruding the molten resin through a die to form a tube of molten polymer (i.e. a parison); 3) clamping a mold having the desired finished shape around the parison; 4) blowing air into the parison, causing the extrudate to stretch and expand to fill the mold; 5) cooling the molded article; 6) ejecting the article from the mold; and 7) removing excess plastic (commonly referred to as flash) from the article.

The hot parison that is extruded in this process often must hang for several seconds under its own weight prior to the mold being clamped around it. During this time, the extrudate must have good molten dimensional stability, also known as melt strength. Melt strength is directly related to the viscosity of the material at low shear rates, such as 1 sec⁻¹. A material with good melt strength (i.e. high viscosity) can resist stretching and flowing (a.k.a. sag) that would cause uneven material distribution in the parison and thinning of the parison walls. The sag of the extruded parison is directly related to the weight of the parison, whereby larger and heavier parisons will have a greater tendency to sag. Heavier parisons are required as bottle size increases, whereby the production of larger bottles requires higher melt strength. Materials with high melt strength will also resist tearing while the parison is blown into a bottle. Thus, good melt strength is required to form good quality containers, particularly those of larger size, that have uniform side wall thickness and that will not tear during expansion (i.e. blowing).

Unfortunately, extrusion at high speed can create a condition known as “sharkskin” on the surface of the extruded part or article. Sharkskin (a form of melt fracture) is visually observable as a frosty white matte surface haze, and is an undesirable defect in transparent bottles. Sharkskin is a rheological flow instability phenomenon that occurs as molten polymer flows at high shear rates over a metal surface, such as the surface of the extruder die. Shear rates between 100 sec⁻¹ and 1000 seq⁻¹ are typically generated at the die due to the need to obtain reasonably fast production rates while simultaneously generating thin walls for lightweight bottles.

Sharkskin can be avoided by increasing the process melt temperature, which lowers the material's viscosity, but this also leads to a reduction in melt strength. Nonetheless, the shear rate associated with melt strength is typically only around 1 sec⁻¹. Thus, a material with both good melt strength (i.e. high viscosity) at low shear rates and resistance to sharkskin (i.e. low viscosity) at high shear rates is highly desirable for extrusion blow molding. This behavior is referred to as shear thinning.

The typical PET resins used to ISBM beverage containers are believed to be difficult to extrusion blow mold due to their relatively low inherent viscosities (IhV≦0.90 dL/g) and high crystalline melting points (>245° C.) which leaves them with low melt strength at the temperatures needed to process them into extrusion blow molded articles. These ISBM PET resins can be further solid stated to increase viscosity, but these compositions still do not have sufficient shear thinning behavior to prevent sharkskin. Numerous attempts have been made to add branching agents to PET to improve the shear thinning characteristics, but these compositions are believed to require solid stating. Solid stated branched PET compositions are particularly prone to issues with gels and unmelts during the EBM process.

In order to overcome these problems, U.S. Pat. No. 4,983,711 describes totally amorphous copolyester compositions related to PET that are particularly useful in extrusion blow molding processes. These compositions comprise terephthalic acid or DMT moieties with ethylene glycol and 25 to 75 mole % 1,4-cyclohexanedimethanol and 0.05 to 1 mole % of a branching agent. These compositions are particularly desirable for extrusion blow molded beverage containers since they yield containers with clarity, gloss and toughness similar to ISBM PET containers. Unfortunately, copolyesters of the compositions described in U.S. Pat. No. 4,983,711 can have high levels of sharkskin problems when processed on high output processing equipment such as EBM wheel machines.

Compatibility with the PET recycle stream is also a desirable characteristic for EBM containers, especially through-handle containers. The Association of Post Consumer Plastic Recyclers (2000 L Street, N.W., Suite 835, Washington, D.C. 20036) have published the PET Critical Guidance Document for Innovations (“CGD”) as a screening tool to help the innovator understand the approximate effect of the innovation (e.g., new polyester composition) on plastic bottle recycling. http://www.plasticsforming.com/pdf/petpdf, accessed on Jul. 25, 2011. Tests are performed on blends of the innovation polyester and one of several specific PET commercial products; the blends are prepared as specified in the CGD. Tests include a filterability test, solid stating performance test, intrinsic viscosity (ItV) drop test, melting point test, and color tests. The CGD also addresses other issues such as, for example, the need for no sticking between flakes during drying.

Unfortunately, containers made from compositions described by U.S. Pat. No. 4,983,711 can cause problems in the PET recycle stream. Ground flake from these containers can stick to the walls of the dryer or agglomerate with PET container flake in a dryer set at 140-180° C. Mixing ground flake from these containers into PET container flake could also result in hazy film, sheet, or bottles. Also, at a 50/50 wt/wt blend of the compositions described in U.S. Pat. No. 4,983,711 with PET, these compositions could lower the melting point temperature of the blend beyond acceptable limits. A desirable solution is to find a material that can be both extrusion blow molded into transparent containers, but will be non-problematic in the PET recycle stream at levels much higher than they will typically be present in the recycle stream.

Thus, there is a need in the art for a transparent material with high resistance to sharkskin in extrusion blow molding that will also be non-problematic in the PET recycle stream. Specifically, there is a need for a material useful in making extrusion blow molded containers that when blended with PET for recycle, does not lower the melting point temperature of the blend outside of a desired range.

### SUMMARY OF THE INVENTION

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, 2,2,4,4-tetramethyl-1,3-cyclobutanediol, isosorbide, or mixtures thereof;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, or mixtures thereof;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of 1,4-cyclohexanedimethanol;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, 2,2,4,4-tetramethyl-1,3-cyclobutanediol, isosorbide, or mixtures thereof;
(c) at least one branching agent in the amount ranging from 0.1 to 0.6 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, or mixtures thereof;
(c) at least one branching agent in the amount ranging from 0.1 to 0.6 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of 1,4-cyclohexanedimethanol;
(c) at least one branching agent in the amount ranging from 0.1 to 0.6 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, 2,2,4,4-tetramethyl-1,3-cyclobutanediol, isosorbide, or mixtures thereof;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 0.9 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, or mixtures thereof;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 0.9 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of 1,4-cyclohexanedimethanol;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 0.9 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, 2,2,4,4-tetramethyl-1,3-cyclobutanediol, isosorbide, or mixtures thereof;
(c) at least one branching agent in the amount ranging from 0.1 to 0.6 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 0.9 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, or mixtures thereof;
(c) at least one branching agent in the amount ranging from 0.1 to 0.6 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 0.9 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which consists of:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of 1,4-cyclohexanedimethanol;
(c) at least one branching agent in the amount ranging from 0.1 to 0.6 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 0.9 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, 2,2,4,4-tetramethyl-1,3-cyclobutanediol, isosorbide, or mixtures thereof;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 235 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, or mixtures thereof;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 235 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of 1,4-cyclohexanedimethanol;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.; and
   wherein the melting point temperature (Tₘ) of a blend of 50 weight % of said polyester with 50 weight % of a PET Recycle Standard ranges from 235 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, 2,2,4,4-tetramethyl-1,3-cyclobutanediol, isosorbide, or mixtures thereof;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.;
   wherein said article has a sidewall haze value of less than 15% as measured by ASTM D1003 Method A; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, or mixtures thereof;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.;
   wherein said article has a sidewall haze value of less than 15% as measured by ASTM D1003 Method A; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of 1,4-cyclohexanedimethanol;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.;
   wherein said article has a sidewall haze value of less than 15% as measured by ASTM D1003 Method A; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, 2,2,4,4-tetramethyl-1,3-cyclobutanediol, isosorbide, or mixtures thereof;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 0.9 dL/g as determined in 60/40 (wt/wt) phenol/tetrachloroethane at a concentration of 0.25 g/50 ml at 25° C.;
   wherein said article has a sidewall haze value of less than 15% as measured by ASTM D1003 Method A; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, or mixtures thereof;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 0.9 dL/g as determined in 60/40 (wt/wt) phenol/tetrachloroethane at a concentration of 0.25 g/50 ml at 25° C.;
   wherein said article has a sidewall haze value of less than 15% as measured by ASTM D1003 Method A; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of 1,4-cyclohexanedimethanol;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 0.9 dL/g as determined in 60/40 (wt/wt) phenol/tetrachloroethane at a concentration of 0.25 g/50 ml at 25° C.;
   wherein said article has a sidewall haze value of less than 15% as measured by ASTM D1003 Method A; and
   wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, 2,2,4,4-tetramethyl-1,3-cyclobutanediol, isosorbide, or mixtures thereof;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.;
   wherein said article has a sidewall haze value of less than 15% as measured by ASTM D1003 Method A; and
   wherein the melting point temperature (Tₘ) of a blend of 50 weight % of said polyester with 50 weight % of a PET Recycle Standard ranges from 235 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of at least one difunctional glycol chosen from 1,4-cyclohexanedimethanol, neopentyl glycol, or mixtures thereof;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and
   the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.;
   wherein said article has a sidewall haze value of less than 15% as measured by ASTM D1003 Method A; and
   wherein the melting point temperature (Tₘ) of a blend of 50 weight % of said polyester with 50 weight % of a PET Recycle Standard ranges from 235 to 245° C. as determined by ASTM D3418 at a scan rate of 10° C./min on a sample prepared using a Recycle Sample Prep Protocol.

In one aspect, this invention provides an extrusion blow molded article comprising at least one polyester which comprises:
(a) a dicarboxylic acid component comprising:
   (i) 90 to 100 mole % of terephthalic acid residues;
   (ii) 0 to 10 mole % of aromatic and/or aliphatic dicarboxylic acid residues having up to 20 carbon atoms; and
(b) a glycol component comprising:
   (i) 88 to 93 mole % of ethylene glycol residues; and
   (ii) 7 to 12 mole % residues of 1,4-cyclohexanedimethanol;
(c) at least one branching agent in the amount ranging from 0.1 to 1.0 mole % based on the total moles of glycol residues if said branching agent has hydroxyl substituents and otherwise based on the total moles of acid residues;
   wherein the total mole % of the acid residues is 100 mole %, and the total mole % of the glycol residues is 100 mole %;
   wherein the inherent viscosity (IhV) of the polyester ranges from 0.7 to 1.1 dL/g as determined in 60/40 (wt/wt) phenol/tetrachloroethane at a concentration of 0.25 g/50 ml at 25° C.;
   wherein said article has a sidewall haze value of less than 15% as measured by ASTM D1003 Method A; and
   wherein the melting point temperature (Tₘ) of a blend of 50 weight % of said polyester with 50 weight % of a PET Recycle Standard ranges from 235 to 245° C. as determined by ASTM D3418 at a scan rate of 10° C./min on a sample prepared using a Recycle Sample Prep Protocol.

In one aspect, this invention provides an extrusion blow molding process comprising: extrusion blow molding a polyester at a shear rate of at least 450 sec⁻¹ to thereby form an extrusion blow molded article, wherein said extrusion blow molded article has a sidewall haze of less than 15% as measured by ASTM D 1003, Method A; wherein said polyester comprises a dicarboxylic acid component and a glycol component, wherein said dicarboxylic acid component comprises at least 90 mole % terephthalic acid residues wherein said glycol component comprises 88 to 93 mole % of ethylene glycol residues and 7 to 12 mole % of residues chosen from 1,4-cyclohexanedimethanol, neopentyl glycol, 2,2,4,4-tetramethyl-1,3-cyclobutanediol, isosorbide, or mixtures thereof; and wherein the melting point temperature of a blend of 50 weight % of said polyester with 50 weight % a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molding process comprising: extrusion blow molding a polyester at a shear rate of at least 450 sec⁻¹ to thereby form an extrusion blow molded article, wherein said extrusion blow molded article has a sidewall haze of less than 15% as measured by ASTM D 1003, Method A; wherein said polyester comprises a dicarboxylic acid component and a glycol component, wherein said dicarboxylic acid component comprises at least 90 mole % terephthalic acid residues wherein said glycol component comprises 88 to 93 mole % of ethylene glycol residues and 7 to 12 mole % of residues chosen from 1,4-cyclohexanedimethanol, neopentyl glycol, or mixtures thereof; and wherein the melting point temperature of a blend of 50 weight % of said polyester with 50 weight % a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molding process comprising: extrusion blow molding a polyester at a shear rate of at least 450 sec⁻¹ to thereby form an extrusion blow molded article, wherein said extrusion blow molded article has a sidewall haze of less than 15% as measured by ASTM D 1003, Method A; wherein said polyester comprises a dicarboxylic acid component and a glycol component, wherein said dicarboxylic acid component comprises at least 90 mole % terephthalic acid residues wherein said glycol component comprises 88 to 93 mole % of ethylene glycol residues and 7 to 12 mole % of 1,4-cyclohexanedimethanol residues; and wherein the melting point temperature of a blend of 50 weight % of said polyester with 50 weight % a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molding process comprising: extrusion blow molding a polyester at a shear rate of at least 650 sec⁻¹ to thereby form an extrusion blow molded article, wherein said extrusion blow molded article has a sidewall haze of less than 15% as measured by ASTM D 1003, Method A; wherein said polyester comprises a dicarboxylic acid component and a glycol component, wherein said dicarboxylic acid component comprises at least 90 mole % terephthalic acid residues wherein said glycol component comprises 88 to 93 mole % of ethylene glycol residues and 7 to 12 mole % of residues chosen from 1,4-cyclohexanedimethanol, neopentyl glycol, 2,2,4,4-tetramethyl-1,3-cyclobutanediol, isosorbide, or mixtures thereof; and wherein the melting point temperature of a blend of 50 weight % of said polyester with 50 weight % a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molding process comprising: extrusion blow molding a polyester at a shear rate of at least 650 sec⁻¹ to thereby form an extrusion blow molded article, wherein said extrusion blow molded article has a sidewall haze of less than 15% as measured by ASTM D 1003, Method A; wherein said polyester comprises a dicarboxylic acid component and a glycol component, wherein said dicarboxylic acid component comprises at least 90 mole % terephthalic acid residues wherein said glycol component comprises 88 to 93 mole % of ethylene glycol residues and 7 to 12 mole % of residues chosen from 1,4-cyclohexanedimethanol, neopentyl glycol, or mixtures thereof; and wherein the melting point temperature of a blend of 50 weight % of said polyester with 50 weight % a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molding process comprising: extrusion blow molding a polyester at a shear rate of at least 650 sec⁻¹ to thereby form an extrusion blow molded article, wherein said extrusion blow molded article has a sidewall haze of less than 15% as measured by ASTM D 1003, Method A; wherein said polyester comprises a dicarboxylic acid component and a glycol component, wherein said dicarboxylic acid component comprises at least 90 mole % terephthalic acid residues wherein said glycol component comprises 88 to 93 mole % of ethylene glycol residues and 7 to 12 mole % of 1,4-cyclohexanedimethanol residues; and wherein the melting point temperature of a blend of 50 weight % of said polyester with 50 weight % a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molding process comprising: extrusion blow molding a polyester at a shear rate of at least 450 sec⁻¹ to thereby form an extrusion blow molded article, wherein said extrusion blow molded article has a sidewall haze of less than 10% as measured by ASTM D 1003, Method A; wherein said polyester comprises a dicarboxylic acid component and a glycol component, wherein said dicarboxylic acid component comprises at least 90 mole % terephthalic acid residues wherein said glycol component comprises 88 to 93 mole % of ethylene glycol residues and 7 to 12 mole % of residues chosen from 1,4-cyclohexanedimethanol, neopentyl glycol, 2,2,4,4-tetramethyl-1,3-cyclobutanediol, isosorbide, or mixtures thereof; and wherein the melting point temperature of a blend of 50 weight % of said polyester with 50 weight % a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molding process comprising: extrusion blow molding a polyester at a shear rate of at least 450 sec⁻¹ to thereby form an extrusion blow molded article, wherein said extrusion blow molded article has a sidewall haze of less than 10% as measured by ASTM D 1003, Method A; wherein said polyester comprises a dicarboxylic acid component and a glycol component, wherein said dicarboxylic acid component comprises at least 90 mole % terephthalic acid residues wherein said glycol component comprises 88 to 93 mole % of ethylene glycol residues and 7 to 12 mole % of residues chosen from 1,4-cyclohexanedimethanol, neopentyl glycol, or mixtures thereof; and wherein the melting point temperature of a blend of 50 weight % of said polyester with 50 weight % a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molding process comprising: extrusion blow molding a polyester at a shear rate of at least 450 sec⁻¹ to thereby form an extrusion blow molded article, wherein said extrusion blow molded article has a sidewall haze of less than 10% as measured by ASTM D 1003, Method A; wherein said polyester comprises a dicarboxylic acid component and a glycol component, wherein said dicarboxylic acid component comprises at least 90 mole % terephthalic acid residues wherein said glycol component comprises 88 to 93 mole % of ethylene glycol residues and 7 to 12 mole % of 1,4-cyclohexanedimethanol residues; and wherein the melting point temperature of a blend of 50 weight % of said polyester with 50 weight % a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molding process comprising: extrusion blow molding a polyester at a shear rate of at least 450 sec⁻¹ to thereby form an extrusion blow molded article, wherein said extrusion blow molded article has a sidewall haze of less than 15% as measured by ASTM D 1003, Method A; wherein said polyester comprises a dicarboxylic acid component and a glycol component, wherein said dicarboxylic acid component comprises at least 90 mole % terephthalic acid residues wherein said glycol component comprises 88 to 93 mole % of ethylene glycol residues and 7 to 12 mole % of residues chosen from 1,4-cyclohexanedimethanol, neopentyl glycol, 2,2,4,4-tetramethyl-1,3-cyclobutanediol, isosorbide, or mixtures thereof and at least one branching agent in the amount ranging from 0.10 to 1.0 mole % based on the total mole of glycol residues if said branching agent has hydroxyl substituents and otherwise based on the total moles of acid residues; wherein the inherent viscosity (IhV) of said polyester ranges from 0.7 to 1.1 dL/g as determined in 60/40 (wt/wt) phenol/tetrachloroethane at a concentration of 0.25 g/50 ml at 25° C.; and wherein the melting point temperature of a blend of 50 weight % of said polyester with 50 weight % a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molding process comprising: extrusion blow molding a polyester at a shear rate of at least 450 sec⁻¹ to thereby form an extrusion blow molded article, wherein said extrusion blow molded article has a sidewall haze of less than 15% as measured by ASTM D 1003, Method A; wherein said polyester comprises a dicarboxylic acid component and a glycol component, wherein said dicarboxylic acid component comprises at least 90 mole % terephthalic acid residues wherein said glycol component comprises 88 to 93 mole % of ethylene glycol residues and 7 to 12 mole % of residues chosen from 1,4-cyclohexanedimethanol, neopentyl glycol, or mixtures thereof and at least one branching agent in the amount ranging from 0.10 to 1.0 mole % based on the total mole of glycol residues if said branching agent has hydroxyl substituents and otherwise based on the total moles of acid residues; wherein the inherent viscosity (IhV) of said polyester ranges from 0.7 to 1.1 dL/g as determined in 60/40 (wt/wt) phenol/tetrachloroethane at a concentration of 0.25 g/50 ml at 25° C.;; and wherein the melting point temperature of a blend of 50 weight % of said polyester with 50 weight % a PET Recycle Standard ranges from 230 to 245° C. as determined by ASTM D3418 at a scan rate of 10° C./min on a sample prepared using a Recycle Sample Prep Protocol.

In one aspect, this invention provides an extrusion blow molding process comprising: extrusion blow molding a polyester at a shear rate of at least 450 sec⁻¹ to thereby form an extrusion blow molded article, wherein said extrusion blow molded article has a sidewall haze of less than 15% as measured by ASTM D 1003, Method A; wherein said polyester comprises a dicarboxylic acid component and a glycol component, wherein said dicarboxylic acid component comprises at least 90 mole % terephthalic acid residues wherein said glycol component comprises 88 to 93 mole % of ethylene glycol residues and 7 to 12 mole % of 1,4-cyclohexanedimethanol residues and at least one branching agent in the amount ranging from 0.10 to 1.0 mole % based on the total mole of glycol residues if said branching agent has hydroxyl substituents and otherwise based on the total moles of acid residues; wherein the inherent viscosity (IhV) of said polyester ranges from 0.7 to 1.1 dL/g as determined in 60/40 (wt/wt) phenol/tetrachloroethane at a concentration of 0.25 g/50 ml at 25° C.; and wherein the melting point temperature of a blend of 50 weight % of said polyester with 50 weight % a PET Recycle Standard ranges from 230 to 245° C. as determined by ASTM D3418 at a scan rate of 10° C./min on a sample prepared using a Recycle Sample Prep Protocol.

In one aspect of the invention, diethylene glycol is present in the polyesters useful in the invention in the amount of 2 mole % or less.

In one aspect of the invention, the branching agent can be chosen from at least one of the following: trimellitic acid, trimellitic anhydride, trimethylolpropane, pentaerythritol, and trimethylolethane.

In one aspect of the invention, an extrusion blow molded article is provided wherein the difunctional glycol residues are chosen from at least one of 1,4-cyclohexanedimethanol and neopentyl glycol.

In one aspect of the invention, an extrusion blow molded article is provided wherein the difunctional glycol residues consist essentially of ethylene glycol and 1,4-cyclohexanedimethanol.

In one aspect of the invention, an extrusion blow molded article is provided wherein the difunctional glycol residues consists of ethylene glycol and 1,4-cyclohexanedimethanol.

In one aspect of the invention, an extrusion blow molded article is provided wherein the polyester comprises: 8 to 10 mole % 1,4-cyclohexanedimethanol residues or 10 mole % 1,4-cyclohexanedimethanol residues, wherein the total moles of glycol residues is 100 mole %.

In one aspect of the invention, an extrusion blow molded article is provided wherein the inherent viscosity (IhV) of the polyester ranges from 0.7 to 0.9 dL/g.

In one aspect of the invention, an extrusion blow molded article is provided wherein the inherent viscosity (IhV) of the polyester ranges from 0.75 to 0.88 dL/g.

In one aspect of the invention, an extrusion blow molded article is provided wherein the inherent viscosity (IhV) of the polyester ranges from 0.77 to 0.82 dL/g.

In one aspect of the invention, an extrusion blow molded article is provided wherein the polyester composition can comprise at least one additive chosen from colorants, mold release agents, phosphorus compounds, plasticizers, nucleating agents, UV stabilizers, glass fiber, carbon fiber, fillers, and impact modifiers.

In one aspect of the invention, the extrusion blow molded article can be a container.

In one aspect of the invention, the extrusion blow molded article can be a bottle.

In one aspect of the invention, the extrusion blow molded article can be a bottle with a handle.

In one aspect of the invention, the extrusion blow molded article can be a container or bottle having an internal volume of at least 1 liter or at least 2 liters; or a bottle having a through-handle.

In one aspect of the invention, an extrusion blow molding process is provided comprising: extrusion blow molding the polyester of the invention at a shear rate of at least 450 sec⁻¹ to thereby form an extrusion blow molded article, wherein said extrusion blow molded article has a sidewall haze of less than 15%.

In one aspect of the invention, the extrusion blow molding process is carried out at a shear rate of at least 550 sec⁻¹.

In one aspect of the invention, the extrusion blow molding process results in an extrusion blow molded article having a sidewall haze of less than 10%.

In one aspect of the invention, the extrusion blow molding process of the invention is carried out at a shear rate of at least 650 sec⁻¹.

In one aspect of the invention, the extrusion blow molding process results in an extrusion blow molded article having a sidewall haze of less than 5%.

In one aspect of the invention, the extrusion blow molding process results in a molded article, for example, a container or bottle having an internal volume of at least 1 liter or at least 2 liters; or a bottle having a through-handle.

This invention is believed to provide a transparent material with high resistance to sharkskin in extrusion blow molding. This invention is also believed to be useful for extrusion blow molding into transparent containers, and is believed to have the additional advantage of being non-problematic in the PET recycle stream, specifically having an acceptably limited impact on the PET recycle stream melting point temperature.

### DETAILED DESCRIPTION OF THE INVENTION

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

It is believed that certain polyesters and/or polyester composition(s) useful in the invention formed from terephthalic acid, an ester thereof, and/or mixtures thereof, ethylene glycol, and at least one difunctional glycol, and a branching agent, can have a unique combination of two or more of the following properties: (1) little or no haze when extrusion blow molded under conditions of high shear; (2) high resistance to sharkskin formation when extrusion blow molded under conditions of high shear; (3) compatible in the PET recycle stream; and (4) a melting point temperature (Tₘ) of greater than 235° C. or greater than 230° C. of a blend of the polyester with a PET Recycle Standard at a weight ratio of 50:50.

It is believed that the extrusion blow molding process(es) and/or the process(es) used in making the articles according to the present invention are improved because, for example, the extrusion blow molding process(es) can be carried out at higher output rates.

The term “polyester,” as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds. Typically the difunctional carboxylic acid can be a dicarboxylic acid and the difunctional hydroxyl compound can be a dihydric alcohol such as, for example, glycols and diols. The term “glycol” as used herein includes, but is not limited to, diols, glycols, and/or multifunctional hydroxyl compounds, for example, branching agents. As used herein, the term “dicarboxylic acid” is intended to include dicarboxylic acids as well as multifunctional carboxylic acids and any derivative of a dicarboxylic acid or multifunctional carboxylic acid, for example, branching agents. The term “dicarboxylic acid” also includes the associated acid halides, esters, half-esters, salts, half-salts, anhydrides, mixed anhydrides, and/or mixtures thereof, useful in a reaction process with a diol to make polyester. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. The term “residue,” as used herein, means any organic structure incorporated into a polymer through a polycondensation and/or an esterification reaction from the corresponding monomer. The term “repeating unit,” as used herein, means an organic structure having a dicarboxylic acid residue (acid residue) and a diol residue (glycol residue) bonded through a carbonyloxy group. Thus, for example, the term “dicarboxylic acid residues,” is used interchangeable with the term “acid residues,” and may be derived from a dicarboxylic acid monomer or its associated acid halides, esters, salts, anhydrides, and/or mixtures thereof. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make polyester.

The polyesters used in the present invention typically can be prepared from dicarboxylic acids and glycols which react in substantially equal proportions and are incorporated into the polyester polymer as their corresponding residues. The polyesters of the present invention, therefore, can contain substantially equal molar proportions of acid residues (100 mole %) and glycol residues (100 mole %) such that the total moles of repeating units is equal to 100 mole %. The mole percentages provided in the present disclosure, therefore, may be based on the total moles of acid residues, the total moles of glycol residues, or the total moles of repeating units. For example, a polyester containing 10 mole % isophthalic acid, based on the total acid residues, means the polyester contains 10 mole % isophthalic acid residues out of a total of 100 mole % acid residues. Thus, there are 10 moles of isophthalic acid residues among every 100 moles of acid residues. In another example, a polyester containing 15 mole % 1,4-cyclohexanedimethanol out of a total of 100 mole % glycol residues has 15 moles of 1,4-cyclohexanedimethanol residues among every 100 moles of glycol residues. Also, for example, a polyester containing 0.5 mole % trimellitic anhydride residues contains 0.5 moles of trimellitic anhydride residues for every 100 moles of acid residues. Likewise, a polyester containing 0.5 mole % trimethylolpropane residues contains 0.5 moles of trimethylolpropane residues for every 100 moles of glycol residues.

As used herein, the term “branching agent” is equivalent to branching monomer and is a multifunctional compound with either hydroxyl or carboxyl substituents that can react with the difunctional monomers of the polyester. The term “multifunctional” refers to functional compounds that are not mono-functional or difunctional.

As used herein the term “extrusion blow molding process” has its usual meaning to one skilled in the art and includes any extrusion blow molding manufacturing process known in the art. Although not limited thereto, a typical description of extrusion blow molding manufacturing process involves: 1) melting the resin in an extruder; 2) extruding the molten resin through a die to form a tube of molten polymer (i.e. a parison); 3) clamping a mold having the desired finished shape around the parison; 4) blowing air into the parison, causing the extrudate to stretch and expand to fill the mold; 5) cooling the molded article; 6) ejecting the article from the mold; and 7) removing excess plastic (commonly referred to as flash) from the article. As used herein, the term “extrusion blow molded article” is any article made by an extrusion blow molding process including but not limited to a container, a bottle, or a through-handle bottle.

The term “container” as used herein is understood to mean a receptacle in which material is held or stored. Containers include but are not limited to bottles, bags, vials, tubes and jars. Applications in the industry for these types of containers include but are not limited to food, beverage, cosmetics, and personal care applications.

The term “bottle” as used herein is understood to mean a receptacle containing plastic which is capable of storing or holding liquid.

As used herein, the term “haze” is the ratio of diffuse transmittance to total light transmittance. Haze is measured on sidewalls of extrusion blow molded articles according to ASTM D 1003, Method A, and is calculated as a percentage. A BYK-Gardner HazeGuard Plus was used to measure haze.

As used herein the term “inherent viscosity” or “IhV” is the viscosity of a dilute solution of the polymer, specifically IhV is defined as the viscosity of a 60/40 (wt/wt) phenol/tetrachloroethane at a concentration of 0.25 g polyester per 50 ml solution at a specified temperature of either 25° C. or 30° C.

As used herein, the term “intrinsic viscosity” or “ItV” is the ratio of a solutions specific viscosity to the concentration of the solute extrapolated to zero concentration. ItV may be calculated from the measured inherent viscosity.

As used herein, the term “melting point temperature” or “Tₘ” is the peak minimum of the endotherm on a DSC thermal curve.

As used herein, the term “PET Recycle Standard” refers to the virgin resin used to test the compatibility of a given polyester with PET recycle streams and is defined further herein.

As used herein, the term “Recycle Sample Prep Protocol” refers to the process for making a sample which includes a given polyester and a control PET resin and is defined further herein. A control PET resin may be a PET Recycle Standard resin.

As used herein, the term “shear rate” has its usual meaning to those skilled in the art as the rate at which shear is applied and has units of reciprocal seconds (s⁻¹).

As used herein, the term “solid-state polycondensation” refers to the increase in molecular weight of the pellet by subjecting the solid pellet to an elevated temperature to increase the inherent viscosity (IhV) of the pellet at least 0.01 dL/g, more typically 0.05 to 0.5 dL/g. Consequently, if a polyester has not been subject to solid-state polycondensation, the difference in the inherent viscosity of the final polyester pellet and the inherent viscosity of the amorphous pellet produced from the melt-phase reactor effluent is less than 0.01 dL/g.

In certain embodiments, the dicarboxylic acid component used to make the polyesters useful in the invention can comprise, consist essentially of, or consist of terephthalic acid or an ester thereof, (e.g., dimethyl terephthalate) or a mixture of terephthalic acid residues and an ester thereof. In certain embodiments, terephthalic acid residues can make up a portion or all of the dicarboxylic acid component used to form the polyesters useful in the invention.

In one embodiment, dimethyl terephthalate is part or all of the dicarboxylic acid component used to make the polyesters useful in the present invention. In certain embodiments, terephthalic acid and/or dimethyl terephthalate and/or mixtures thereof are present in the polyester in one of the following amounts based on total acid residues: 85 to 100 mole %; or 90 to 100 mole %; or 93 to 100 mole %; or 95 to 100 mole %; or 96 to 100 mole %; or 97 to 100 mole %; or 98 to 100 mole %; or 99 to 100 mole %; or 100 mole %.

In addition to terephthalic acid and/or dimethyl terephthalate, the dicarboxylic acid component of the polyesters useful in the invention can comprise up to 15 mole %, up to 10 mole %, up to 7 mole %, up to 5 mole %, up to 4 mole %, up to 3 mole %, up to 2 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, 0.01 to 5 mole %, and 0.01 to 1 mole %. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The dicarboxylic acid component of the polyesters useful in the invention can be modified with up to 15 mole % up to 10 mole %, up to 7 mole %, up to 5 mole %, up to 4 mole %, up to 3 mole %, up to 2 mole %, or up to 1 mole % of one or more aliphatic dicarboxylic acids containing 2 to 16 carbon atoms, such as, for example, cyclohexanedicarboxylic, malonic, succinic, glutaric, adipic, pimelic, suberic, azelaic and dodecanedioic dicarboxylic acids. Certain embodiments can also comprise 0.01 to 10 mole %, 0.1 to 5 mole %, or 1 to 5 mole % of one or more modifying aliphatic dicarboxylic acids. Yet another embodiment contains 0 mole % modifying aliphatic dicarboxylic acids. In one embodiment, adipic acid and/or glutaric acid are provided in the modifying aliphatic dicarboxylic acid component of the invention.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In certain embodiments of the invention, the glycol component employed in making the polyesters useful in the invention can comprise, consist essentially of, or consist of ethylene glycol and one or more difunctional glycols chosen from 1,4-cyclohexanedimethanol, neopentyl glycol, 2,2,4,4-tetramethyl-1,3-cyclobutanediol, isosorbide (CAS registration number 652-67-5), diethylene glycol, 1,2-propanediol, 1,5-pentanediol, 1,6-hexanediol, p-xylene glycol, 1,3-propanediol, 1,4-butanediol, and mixtures thereof. When the glycol component comprises residues of 1,4-cyclohexanedimethanol and ethylene glycol, these components can be present in one of the following combinations of ranges: 4 to 15 mole % 1,4-cyclohexanedimethanol, and 85 to 96 mole % ethylene glycol; 4 to 12 mole % 1,4-cyclohexanedimethanol, and 88 to 96 mole % ethylene glycol; 4 to 10 mole % 1,4-cyclohexanedimethanol, and 80 to 96 mole % ethylene glycol; 5 to 15 mole % 1,4-cyclohexanedimethanol, and 85 to 95 mole % ethylene glycol; 5 to 12 mole % 1,4-cyclohexanedimethanol and 88 to 95 mole % ethylene glycol; 5 to 10 mole % 1,4-cyclohexanedimethanol, and 90 to 95 mole % ethylene glycol; 6 to 15 mole % 1,4-cyclohexanedimethanol, and 85 to 94 mole % ethylene glycol; 6 to 12 mole % 1,4-cyclohexanedimethanol, and 88 to 94 mole % ethylene glycol; 6 to 10 mole % 1,4-cyclohexanedimethanol, and 90 to 94 mole % ethylene glycol; 7 to 15 mole % 1,4-cyclohexanedimethanol, and 85 to 93 mole % ethylene glycol; 7 to 12 mole % 1,4-cyclohexanedimethanol, and 88 to 93 mole % ethylene glycol; 7 to 11 mole % 1,4-cyclohexanedimethanol, and 89 to 93 mole % ethylene glycol; 7 to 10 mole % 1,4-cyclohexanedimethanol, and 90 to 93 mole % ethylene glycol; 8 to 15 mole % 1,4-cyclohexanedimethanol and 85 to 92 mole % ethylene glycol; and 8 to 12 mole % 1,4-cyclohexanedimethanol and 88 to 92 mole % ethylene glycol.

When 1,4-cyclohexanedimethanol is employed as all or part of the glycol component, the 1,4-cyclohexanedimethanol may be cis, trans, or a mixture thereof. The molar ratio of cis/trans 1,4-cyclohexanedimethanol can vary within the range of 50/50 to 0/100 or 40/60 to 20/80. In one embodiment, the 1,4-cyclohexanedimethanol has a cis/trans ratio of 60:40 to 40:60 or a cis/trans ratio of 70:30 to 30:70. In another embodiment, the trans-cyclohexanedimethanol can be present in an amount of 60 to 80 mole % and the cis-cyclohexanedimethanol can be present in an amount of 20 to 40 mole % wherein the total percentages of cis-cyclohexanedimethanol and trans-cyclohexanedimethanol is equal to 100 mole %. In particular embodiments, the trans-cyclohexanedimethanol can be present in an amount of 60 mole % and the cis-cyclohexanedimethanol can be present in an amount of 40 mole %. In particular embodiments, the trans-cyclohexanedimethanol can be present in an amount of 70 mole % and the cis-cyclohexanedimethanol can be present in an amount of 30 mole %.

In certain embodiments, the glycol component of the polyester useful in the invention can contain up to 1 mole %, 5 mole %, 7 mole %, or 10 mole % of one or more modifying difunctional glycols which are not ethylene glycol, diethylene glycol, or 1,4-cyclohexanedimethanol. In one embodiment, the glycol component of the polyester portion of the polyester compositions useful in the invention can contain from 0.01 to 5 mole % of one or more modifying difunctional glycols which are not ethylene glycol, diethylene glycol, or 1,4-cyclohexanedimethanol. In one embodiment, the glycol component of the polyester portion of the polyester compositions useful in the invention can contain from 0.01 to 2.5 mole % of one or more modifying difunctional glycols which are not ethylene glycol, 1,4-cyclohexanedimethanol, or diethylene glycol. In another embodiment, the polyesters useful in the invention can contain 0 mole % of modifying glycols.

Modifying glycols useful in the polyesters useful in the invention refer to diols other than 1,4-cyclohexanedimethanol, diethylene glycol, and ethylene glycol and can contain 2 to 16 carbon atoms. Examples of suitable modifying glycols include, but are not limited to, 1,2-propanediol, 1,3-propanediol, neopentyl glycol, 1,4-butanediol, 1,5-pentanediol, 1,6-hexanediol, p-xylene glycol, polytetramethylene glycol, 2,2,4,4-tetramethyl-1,3-cyclobutanediol, isosorbide and mixtures thereof. In another embodiment, the modifying glycols include, but are not limited to, at least one of 1,3-propanediol and 1,4-butanediol.

In one embodiment, the diethylene glycol is not added as a separate monomer but is formed during polymerization.

In certain embodiments, the polyester contains a branching agent, the branching agent can be present in an amount of branching residues in the range from 0.05 to 2.0 mole %, 0.05 to 1.5 mole %, 0.05 to 1.0 mole %, 0.05 to 0.8 mole %, 0.05 to 0.6 mole %, 0.1 to 2.0 mole %, 0.1 to 1.5 mole %, 0.1 to 1.0 mole %, 0.1 to 0.8 mole %, 0.1 to 0.6 mole %, 0.2 to 2.0 mole %, 0.2 to 1.5 mole %, 0.2 to 1.0 mole %, 0.2 to 0.8 mole %, 0.2 to 0.6 mole %, 0.3 to 2.0 mole %, 0.3 to 1.5 mole %, 0.3 to 1.0 mole %, 0.3 to 0.8 mole %, 0.3 to 0.6 mole %, 0.5 to 2.0 mole %, 0.5 to 1.5 mole %, 0.5 to 1.0 mole %, or 0.5 to 0.8 mole %. The mole percent of the branching residues is based on the total mole percentage of the glycol residues when the branching agent has hydroxyl substituents and the mole percent of the branching residues is based on the total mole percentage of the acid residues when the branching agent has acid substituents, including associated acid halides, esters, half-esters, salts, half-salts, anhydrides, mixed anhydrides, and/or mixtures thereof.

In certain embodiments, the branching agent present in the polyester has 3 or more carboxyl substituents or hydroxyl substituents. Examples of branching agents include, but are not limited to, multifunctional acids or multifunctional alcohols such as trimellitic acid, trimellitic anhydride, pyromellitic dianhydride, trimethylolpropane, glycerol, sorbitol, 1,2,6-hexanetriol, pentaerythritol, citric acid, tartaric acid, 3-hydroxyglutaric acid, trimesic acid and the like. In one embodiment, the branching agent residues are chosen from at least one of the following: trimellitic acid, trimellitic anhydride, trimethylolpropane, pentaerythritol, and trimethylolethane.

In certain embodiments, the branching agent may be added prior to and/or during and/or after the polymerization of the polyester. The polyester(s) useful in the invention can thus be linear or branched. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

In certain embodiments, the polyesters of the invention can comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 to about 10% by weight, about 0.1 to about 5% by weight, 0.1 to about 2% by weight, or 0.1 to about 1% by weight based on the total weight of the polyester.

For embodiments of the invention, the polyesters useful in the invention may exhibit at least one of the following inherent viscosities as determined in 60/40 (wt/wt) phenol/tetrachloroethane at a concentration of 0.25 g/50 ml at 25° C.: 0.65 to 1.10 dL/g; 0.65 to 1.00 dL/g; 0.65 to 0.95 dL/g; 0.65 to 0.90 dL/g; 0.65 to 0.85 dL/g; 0.65 to 0.80 dL/g; 0.65 to 0.75 dL/g; 0.65 to 0.72 dL/g; 0.65 to 0.70 dL/g; 0.70 to 1.10 dL/g; 0.70 to 1.00 dL/g; 0.70 to 0.95 dL/g; 0.70 to 0.90 dL/g; 0.70 to 0.85 dL/g; 0.70 to 0.80 dL/g; 0.70 to 0.75 dL/g; 0.70 to 0.72 dL/g; 0.72 to 1.1 dL/g; 0.72 to 1.00 dL/g; 0.72 to 0.95 dL/g; 0.72 to 0.90 dL/g; 0.72 to 0.85 dL/g; 0.72 to 0.80 dL/g; 0.72 to 0.78 dL/g; 0.72 to 0.75 dL/g; 0.74 to 1.10 dL/g; 0.74 to 1.00 dL/g; 0.74 to 0.95 dL/g; 0.74 to 0.90 dL/g; 0.74 to 0.85 dL/g; 0.74 to 0.80 dL/g; 0.74 to 0.78 dL/g; 0.76 to 1.10 dL/g; 0.76 to 1.00 dL/g; 0.76 to 0.95 dL/g; 0.76 to 0.90 dL/g; 0.76 to 0.85 dL/g; 0.76 to 0.80 dL/g; 0.76 to 0.78 dL/g; 0.78 to 1.10 dL/g; 0.78 to 1.00 dL/g; 0.78 to 0.95 dL/g; 0.78 to 0.90 dL/g; and 0.78 to 0.85 dL/g.

The inventive composition can be readily included in the overall PET recycle stream. As actual recycle streams of PET may have variability, testing for compatibility with the overall PET recycle stream is done using a virgin PET Recycle Standard resin. The PET Recycle Standard resin is defined herein as a PET resin comprising 96 to 99.5 mole percent terephthalic acid residues and 0.5 to 4.0 mole percent isophthalic acid residues and 100 mole percent ethylene glycol residues based upon 100 mole percent acid residues and 100 mole percent glycol residues (one skilled in the art recognizes that these PET polyesters contain a small amount of DEG produced in situ or added to maintain a constant minimal amount of DEG; the DEG is counted as part of the 100 mole percent of EG). The Association of Postconsumer Plastic Recyclers has developed the PET Critical Guidance Document (“CGD”) for evaluating the compatibility of innovation polyesters with the PET recycle stream. The PET Recycle Standard resin defined above includes, but is not limited to, the named PET Control Resins listed in the CGD and reproduced in the table below.

| | For CSD and non-water bottle |
|---|---|
| For Low IV, water bottle innovation, | innovations, named PET Control |
| named PET Control Resins: | Resins: |
| Eastman aqua PET RH314 | Eastman PET CB12 |
| Invista Polyclear Splash, 3301 | Invista Polyclear Refresh, 1101 |
| M&G Cleartuf Turbo II | M&G Cleartuf MAX |
| Wellman HP 807 | Wellman HP 806 |
| DAK Lasar + W L44A | DAK Laser + B95A |

The CGD includes a procedure for preparing samples of blends of an innovation resin and one of several named PET Control resins to is in various tests. The Recycle Sample Prep Protocol is basued upon, but not limited to, the CGD procedure. The Recycle Sample Prep Protocol is the procedure by which a polyester and a Standard PET Recycle resin are combined and processed before measuring the melting point temperature. The Recycle Sample Prep Protocol is defined as the following Steps 1) through 5).

1) The test polyester and a control PET resin are independently dried, extruded, re-pelletized, and crystallized. Extrusion processing is conducted according to typical PET processing conditions (240-280° C. barrel temperature settings). Crystallization is conducted at approximately 160° C.

2) A pellet-pellet blend is formed by combining the re-pelletized test polyester and the re-pelletized control PET resin from Step 1. The blend is dried at 160° C. for at least 4 hours.

3) The dry blend from Step 2 is extruded, re-pelletized, and crystallized. Extrusion processing is conducted according to typical PET processing conditions (240 to 280° C. barrel temperature settings). Crystallization is conducted at approximately 160° C.

4) The crystallized blend from Step 3 is solid-stated (195-215° C.) until a nominal 0.80 intrinsic viscosity (ItV) is obtained as measured by ASTM D 4603.

5) DSC melting point temperature measurement is conducted on the solid-stated blend from Step 4, according to Method 2 (at 10° C./min, on the second heat scan following annealing for 2 minutes at 280° C.).

Note that the when the control PET resin is one of the named PET Control Resins listed in the CGD and blended with an innovative resin (test polyester) at a level of 0 weight percent, 25 weight percent, or 50 weight percent of the innovative resin, the melting point temperature (Tₘ) of the blend follows the CGD test, 3.1 Melting Point Test, which lists a critical value of 235° C. to 255° C. for the melting point temperature. The control PET resin can be the PET Recycle Standard resin as defined herein above, and the test polyesters can be polyesters useful in the invention.

In one embodiment the melting point temperature Tₘ of a blend comprising 50 weight percent of polyesters useful for the invention with 50 weight percent of a PET Recycle Standard resin and prepared according to the above Recycle Sample Prep Protocol is in the range of 200 to 270° C.; 200 to 260° C.; 200 to 255° C.; 200 to 250° C.; 200 to 245° C.; 200 to 240° C.; 200 to 235° C.; 210 to 270° C.; 210 to 260° C.; 210 to 255° C.; 210 to 250° C.; 210 to 245° C.; 210 to 240° C.; 210 to 235° C.; 220 to 270° C.; 220 to 260° C.; 220 to 255° C.; 220 to 250° C.; 220 to 245° C.; 220 to 240° C.; 220 to 235° C.; 225 to 270° C.; 225 to 260° C.; 225 to 255° C.; 225 to 250° C.; 225 to 245° C.; 225 to 240° C.; 225 to 235° C.; 230 to 270° C.; 230 to 260° C.; 230 to 255° C.; 230 to 250° C.; 230 to 245° C.; 230 to 240° C.; 230 to 235° C.; 235 to 270° C.; 235 to 260° C.; 235 to 255° C.; 235 to 250° C.; 235 to 245° C.; or 235 to 240° C.

It is contemplated that compositions useful in the invention can possess at least one of the inherent viscosity ranges described herein and at least one of the monomer ranges for the compositions described herein unless otherwise stated. It is also contemplated that compositions useful in the invention when blended with the PET Recycle Standard can have at least one of the melting point temperature, Tₘ, ranges described herein and at least one of the monomer ranges for the composition described herein unless otherwise stated. It is contemplated that compositions useful in the invention can possess at least one of the monomer ranges for the compositions described herein, and at least one of the inherent viscosity ranges described herein, and, when blended with the PET Recycle Standard, the blend can have at least one of the melting point temperature, Tₘ, ranges described herein unless otherwise stated.

In one embodiment, the polyesters useful in the invention are produced in the melt-phase and are not subject to solid-state polycondensation which means that any increase in inherent viscosity after the polyester solidifies is less than 0.01 dL/g. In one embodiment, the inherent viscosity may increase in the range from 0.01 to 0.1 dL/g, 0.05 to 0.2 dL/g, or 0.1 to 0.3 dL/g due to solid-state polycondensation.

In one embodiment, the polyesters useful in the invention degrade in IhV during extrusion blow molding (i.e., the IhV of the polyester before the EBM process minus the IhV of the article) is less than 0.1 dL/g, less than 0.075 dL/g, less than 0.05 dL/g, less than 0.03 dL/g, less than 0.02 dL/g.

In addition, the polyester compositions useful in the invention may also contain at least one additive, for example, from 0.01 to 10%, 0.01 to 5%, 0.01 to 2%, or 0.01 to 1% by weight of the overall composition. Common additives include colorants, toner(s), dyes, mold release agents, flame retardants, plasticizers, nucleating agents, stabilizers, including but not limited to, UV stabilizers, thermal stabilizers and/or reaction products thereof, fillers, and impact modifiers. Examples of typical commercially available impact modifiers well known in the art and useful in this invention include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

In addition, certain agents which colorize the polymer can be added to the melt. In one embodiment, a bluing toner is added to the melt in order to reduce the b* of the resulting polyester polymer melt phase product. Such bluing agents include blue inorganic and organic toner(s). In addition, red toner(s) can also be used to adjust the a* color. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyester's raw materials, e.g., ethylene glycol.

The total amount of toner components added depends, of course, on the amount of inherent yellow color in the base polyester and the efficacy of the toner. Generally, a concentration of up to about 15 ppm of combined organic toner components and a minimum concentration of about 0.5 ppm are used. The total amount of bluing additive typically ranges from 0.5 to 10 ppm.

The toner(s) can be added to the esterification zone or to the polycondensation zone. Preferably, the toner(s) are added to the esterification zone or to the early stages of the polycondensation zone, such as to a prepolymerization reactor.

In one embodiment, certain polyesters useful in this invention can be visually clear. The term “visually clear” is defined herein as an appreciable absence of cloudiness, haziness, and/or muddiness, when inspected visually.

In one embodiment, polyesters useful for the invention, when extrusion blow molded into an article, the article has a sidewall haze value of less than 15° A), less than 10%, less than 7° A), less than 5° A), or less than 4% as measured by ASTM D1003, Method A

In one embodiment the article can be a sheet, film, container or bottle. In one embodiment the article is a container. In one embodiment the article is a bottle. In one embodiment, the extrusion blow molded article formed in accordance with the description provided herein is a relatively large container or bottle. The extrusion blow molded article can be a container or bottle having an internal volume of at least 1 liter, at least 1.5 liters, at least 2 liters, at least 2.5 liters, or at least 3 liters. Further, the extrusion blow molded article can be a large container or bottle having an integral through-handle formed by extrusion blow molding.

In one embodiment, certain polyesters useful in the invention can exhibit a melt viscosity (MV) at a shear rate of 1 rad/sec of greater than 20,000 poise, greater than 30,000 poise, or greater than 40,000 poise, where the melt viscosity is measured at 240° C. and 1 rad/sec using a rotary viscometer such as a Rheometrics Dynamic Analyzer (RDA II).

In another aspect, this invention relates to a process for preparing extrusion blow molded articles. The extrusion blow molding process comprises extrusion blow molding a polyester at a shear rate of at least 450 sec⁻¹ to thereby form an extrusion blow molded article. The extrusion blow molded article has a sidewall haze of less than 15° A) as measured by ASTM D 1003, Method A. The polyester comprises a dicarboxylic acid component and a glycol component,

wherein the dicarboxylic acid component comprises at least 90 mole % terephthalic acid residues and the glycol component comprises 88 to 93 mole % of ethylene glycol residues and 7 to 12 mole % 1,4-cyclohexanedimethanol residues. The melting point temperature of a blend of 50 weight % of the polyester with 50 weight % of a PET Recycle Standard ranges from 230 to 245° C. as determined by ASTM D3418 at a scan rate of 10° C./min on a sample prepared using a Recycle Sample Prep Protocol.

The high speed extrusion blow molding process used to form molded articles out of the polyester composition useful in the invention disclosed herein can be carried out at shear rates of at least 450 sec⁻¹, at least 500 sec⁻¹, at least 550 sec⁻¹, or at least 600 sec⁻¹. In one embodiment, the shear rate of the extrusion blow molding process ranges from 500 to 10,000 sec⁻¹, 600 to 5,000 sec⁻¹, or 700 to 2,000 sec⁻¹. Shear rates are calculated from the equation Ÿ=8.6 Q/WH², where Q is the volumetric output rate through the die, W is the width of the die and H is the die gap opening height of the die. The volumetric output rate (Q) is determined by measuring the mass of material extruded over a fixed time interval and dividing by the melt density.

When polyesters according to embodiments of the present invention are extrusion blow molded at one or more of the high shear rates discussed above, they surprisingly exhibit little or no haze. In particular, extrusion blow molded articles made from the inventive polyesters discussed herein at one or more of the shear rates discussed above can exhibit sidewall haze values of less than 15%, less than 10%, less than 7%, less than 5%, or less than 4%. Haze is measured on sidewalls of molded articles according to ASTM D 1003, Method A, and is calculated as a percentage, from the ratio of diffuse transmittance to total light transmittance. A BYK-Gardner HazeGuard Plus is used to measure haze.

In one embodiment, the extrusion blow molded article is formed entirely of the polyester composition useful in the invention. In other embodiments, the polyester composition useful in the invention can be mixed with another composition prior to extrusion blow molding. However, even when the polyester composition useful in the invention is mixed with another composition prior to extrusion blow molding, the resulting extrusion blow molded articles can still contain the novel polyester composition in an amount of at least 90 weight %, at least 95 weight %, at least 98 weight %, or at least 99 weight %.

In one embodiment, the polyesters useful in the invention degrade in IhV during extrusion blow molding (i.e., the IhV of the polyester before the EBM process minus the IhV of the article) is less than 0.1 dL/g, less than 0.075 dL/g, less than 0.05 dL/g, less than 0.03 dL/g, less than 0.02 dL/g.

It is contemplated that the compositions, inherent viscosities, and blend melting point temperatures, listed herein above for a polyester useful for the extrusion blow molded article invention, apply also to the process for extrusion blow molding a polyester.

In another aspect, the invention relates to thermoplastic articles comprising a polyester produced by a process comprising:

(I) heating a mixture comprising the monomers useful in any of the polyesters in the invention in the presence of a catalyst at a temperature of about to 240° C. for a time sufficient to produce an initial polyester;

(II) heating the initial polyester of step (I) at a temperature of 240 to 320° C. for about 1 to 4 hours; and

(III) removing any unreacted glycols.

Suitable catalysts for use in this process include organo-zinc or tin compounds. The use of this type of catalyst is well known in the art. Examples of catalysts useful in the present invention include, but are not limited to, zinc acetate, butyltin tris-2-ethylhexanoate, dibutyltin diacetate, and dibutyltin oxide. Other catalysts may include those based on titanium, zinc, manganese, lithium, germanium, and cobalt. Catalyst amounts typically range from about 10 ppm to about 500 ppm based on the catalyst metal. The process can be carried out in a batch or continuous process.

Typically, step (I) may be carried out under pressure, ranging from atmospheric pressure to 100 psig. The term “reaction product” as used in connection with any of the catalysts useful in the invention refers to any product of a polycondensation and/or esterification reaction with the catalyst and any of the monomers used in making the polyester as well as the product of a polycondensation or esterification reaction between the catalyst and any other type of additive.

Typically, Step (II) and Step (III) can be conducted at the same time. These steps can be carried out by methods known in the art such as by placing the reaction mixture under a pressure ranging from 0.002 psig to atmospheric pressure, or by blowing hot nitrogen gas over the mixture.

It will be apparent to persons skilled in the art that copolyesters of the present invention can be prepared using recycled monomers that have been recovered by depolymerization of scrap or post-consumer polyesters, or a combination of virgin and recycled monomers. Processes for the depolymerization of polyesters into their component monomers are well-known. For example, one known technique is to subject the polyester, typically PET, to methanolysis in which the polyester is reacted with methanol to produce dimethyl terephthalate (“DMT”), dimethyl isophthalate, ethylene glycol (“EG”), and 1,4-cyclohexanedimethanol (“CHDM”), depending on the composition of the polyester. Some representative examples of the methanolysis of PET are described in U.S. Pat. Nos. 3,321,510; 3,776,945; 5,051,528; 5,298,530; 5,576,456; and 6,262,294, which are incorporated herein by reference. In a typical methanolysis process, the scrap PET resin is dissolved in oligomers of dimethyl terephthalate and ethylene glycol. Superheated methanol is then passed through the solution and reacts with the dissolved polyester and polyester oligomers to form dimethyl terephthalate and ethylene glycol. These monomers can be recovered by distillation, crystallization, or a combination thereof. For example, U.S. Pat. No. 5,498,749 describes the recovery and purification of dimethyl terephthalate from depolymerization process mixtures containing 1,4-cyclohexanedimethanol.

Glycolysis is another commonly used method of depolymerizing polyesters. A typical glycolysis process can be illustrated with particular reference to the glycolysis of PET, in which waste PET is dissolved in and reacted with a glycol, typically ethylene glycol, to form a mixture of dihydroxyethyl terephthalate and low molecular weight terephthalate oligomers. This mixture is then subjected to a transesterification with a lower alcohol, i.e., methanol to form dimethyl terephthalate and ethylene glycol. The DMT and ethylene glycol can be recovered and purified by distillation or a combination of crystallization and distillation. Some representative examples of glycolysis methods can be found in U.S. Pat. Nos. 3,907,868; 6,706,843; and 7,462,649, which are incorporated herein by reference.

The recycled DMT and ethylene glycol may be used directly in polycondensation reactions to prepare polyesters and copolyesters. The DMT can be hydrolyzed to prepare terephthalic acid or hydrogenated to CHDM using known procedures. The TPA and CHDM may then be repolymerized into copolyesters.

The recycled monomers can be repolymerized into polyesters using typical polycondensation reaction conditions well-known to persons skilled in the art. They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors. The polyesters may comprise only recycled monomers or a mixture of recycled and virgin monomers. For example, the proportion of the diacid and diol residues that are from recycled monomers can each range from about 0.5 to about 100 mole percent, based on a total of 100 mole percent diacid residues and 100 mole percent diol residues.

Some examples of copolyesters that may be prepared from recycled DMT, dimethyl isophthalate, ethylene glycol, and CHDM prepared from recycled polyester include copolyesters in which the diacid component comprises from about 60 to 100 mole percent of terephthalic acid and the diol component comprises mixtures of CHDM and EG in which the CHDM ranges from 10 to 90 mole percent and the EG ranges from 90 to 10 mole percent. In another example, the diacid component can comprise about 60 to 100 mole percent terephthalic acid and the diol component can comprise mixtures of CHDM and 2,2,4,4-tetramethyl-1,3-cyclobutanediol (“TMCD”) wherein the CHDM ranges from 50-90 mole percent and the TMCD ranges from 10-50 mole percent. In yet another example, the diacid component can comprise 90 to 100 mole percent of terephthalic acid and the diol component can comprise mixtures of CHDM and EG in which the CHDM ranges from 7 to 12 mole percent and the EG ranges from 93 to 88 mole percent. In still another example, the diacid component can comprise mixtures of 50 to 95 mole percent terephthalic acid and 5 to 50 mole percent isophthalic acid. When prepared from recycled monomers of sufficient purity, the above copolyesters are indistinguishable from the same copolyesters prepared from virgin monomers

The equipment used to form the extrusion blow molded article is not particularly limiting and includes any equipment known to one skilled in the art for such purpose. The two types of extrusion blow molding that involve a hanging parison are referred to as “shuttle” and “intermittent” processes. In a shuttle process, the mold is situated on a moving platform that moves the mold up to the extruder die, closes it around the parison while cutting off a section, and then moves away from the die to inflate, cool, and eject the bottle. Due to the mechanics of this process, the polymer is continuously extruded through the die at a relatively slow rate. By contrast, the mold in an intermittent process is fixed below the die opening and the full shot weight (the weight of the bottle plus flash) of polymer must be rapidly pushed through the die after the preceding bottle is ejected but before the current bottle is inflated. Intermittent processes can either utilize a reciprocating screw action to push the parison, or the extrudate can be continuously extruded into a cavity which utilizes a plunger to push the parison.

In a very different type of extrusion blow molding process, a 4 to 20 ft diameter wheel moving at 1 to 10 revolutions per minute grabs the parison as it extrudes from the die and lays it in molds attached to the wheel's outer circumference. Mold closure, parison inflation, cooling, and ejection of the bottle occurs sequentially as the wheel turns. In this “wheel process,” the parison is actually pulled from the die by the wheel whereby good melt strength is required to prevent thinning of the parison during both pulling as well as subsequent blowing. The parison in a wheel process can exit the die in either an upward or downward direction and melt strength will be more crucial during upward extrusion due to the effects of gravity. Because of the continuous nature of this “wheel” process, polymer can be extruded from the die at very high speeds.

In another aspect, this invention relates to a process for recycling polyesters wherein flakes of extrusion blow molded articles and/or profile extrusions made in accordance with embodiments described herein are combined with flakes of recycled PET to thereby form a combined polyester recycle stream. The resulting combined polyester recycle stream can comprise flakes of the extrusion blow molded articles and/or profile extrusions in an amount of at least 5 weight %, at least 10 weight %, at least 15 weight %, at least 20 weight %, or at least 25 weight %. Further, the amount of flakes of the extrusion blow molded articles and/or profile extrusions in the combined polyester recycle stream can be less than 50 weight %, less than 40 weight %, or less than 30 weight %. The combined polyester recycle stream can be processed into articles including, but not limited to, film, sheet, fiber, and ISBM bottles.

The following examples further illustrate how the polyesters of the invention can be made and evaluated, and are intended to be purely exemplary of the invention and are not intended to limit the scope thereof. Unless indicated otherwise, parts are parts by weight, temperature is in degrees C. or is at room temperature, and pressure is at or near atmospheric.

### EXAMPLES

The following abbreviations are used throughout the examples that follow:

| | |
|---|---|
| CHDM | 1,4-cyclohexanedimethanol |
| DMT | Dimethyl therephthalate |
| EG | Ethylene glycol |
| IPA | Isophthalic acid |
| IhV | Inherent viscosity |
| ItV | Intrinsic viscosity |
| Tₘ | Melting point temperature |
| TMA | Trimellitic anhydride |
| TMAc | Trimellitic acid |
| TMAH | Tetramethylamonium hydroxide |

The polyesters of the following examples were prepared by subjecting dimethyl terephthalate to ester interchange with the diols or terephthalic acid to direct condensation with the diols at elevated temperatures in the presence of a catalyst. Thereafter, polycondensation was carried out at increasing temperatures and at reduced pressures until a polyester having the desired inherent viscosity (IhV) was obtained. All pellets were amorphous as they were formed from the polycondensation reactor effluent. The polyesters were not subject to solid-state polycondensation except as specifically noted.

The compositions of the polyesters discussed in the following examples were measured by proton nuclear magnetic resonance (NMR) spectroscopy. All NMR spectra were recorded on a JEOL Eclipse Plus 600 MHz nuclear magnetic resonance spectrometer using chloroform-trifluoroacetic acid (70-30 volume/volume). Note that the reported EG mole % includes any diethylene glycol present.

The trimellitic anhydride (TMA) content of the polyesters was measured using a liquid chromatography technique based on hydrolysis of the polyester. To determine TMA content approximately 0.10 g of sample was weighed into a 20 ml headspace vial, and then the vial was capped and placed into the sample tray of a LEAP Technologies automated liquid handling station. The sample was then hydrolyzed with tetramethylammonium hydroxide (TMAH) in a DMSO/Methanol mixture to yield free TMAc (the acid). The prepared sample was analyzed by high performance ion-exchange chromatography by injection onto a strong anion exchange column for separation from the other components in the sample. Analysis was conducted using an Agilent 1100 HPLC system. The TMAc content was quantified using UV detection. The measured TMAc value was converted to weight equivalent TMA by using the multiplier 0.9143 (the MW ratio of TMA/TMAc). From the calculated weight of TMA, the moles of TMA residues and mole percent TMA based on the total acid residues was readily calculated.

The Inherent Viscosity (IhV) of the polyesters was determined in 60/40 (wt/wt) phenol/tetrachloroethane at a concentration of 0.25 g/50 ml at 30° C., and is reported in dL/g.

The Intrinsic Viscosity (ItV) of the polyesters was calculated from the inherent viscosity (IhV) in 60/40 (wt/wt) phenol/tetrachloroethane at a concentration of 0.25 g/50 ml at 30° C., and is reported in dL/g. Note in the examples, the actual measurement of IhV, and corresponding calculation for ItV, was done using historical calibration factors for the IhV measurement at 25° C., the differences in IhV and ItV values obtained with the historical calibration factor versus a calibration factor at the 30° C. temperature are small, and the stated IhV and ItV measurements are accurate to approximately −/+ 0.02 dL/g.

The crystallization half-time was determined by a TA DSC 2920 instrument on an extruded article. In this test, the article was rapidly (>100 C/min) raised from 23° C. and held at 160° C. until complete crystallization. The half-time is reported based upon the peak maximum of the exothermic heat flow curve.

The melting point temperature (Tₘ) values of the polyesters, Method 1, was obtained by heating the extruded article which had been subject to isothermal crystallization at 160° C., at a rate of 20° C./min, and measuring the peak minimum of the endothermic heat flow curve.

Alternatively, the melting point temperature (Tₘ) values of the polyesters, Method 2, were determined using a TA Q2000 DSC instrument from Thermal Analyst Instruments at a scan rate of 10° C./min according to ASTM D3418. The sample temperature was from 23° C. to 280° C. After annealing for 2 minutes at 280° C., the sample was quenched and a second heat melting scan was performed at the same 10° C./min rate. The reported temperature is the peak minimum of the endothermic heat flow curve of the second heat melting scan.

Moisture was determined by ASTM D 6869, using the Karl Fischer reaction. Pellet sample weights of approximately 1 gram and an oven temperature of 180° C. were used. Results are reported in parts per million (ppm) by weight.

All 30 mil thick extruded film made for film inherent viscosity (IhV) and dryer sticking tests was produced, using a 1.5 inch Killion extruder, fitted with a 12 inch wide flex-lip die. The extruder was run at approximately 80 RPM. The barrel zone and die temperature settings were controlled to approximately 20-40° C., above the reported melting point temperature (Tₘ) of the resin (Table 1). Once produced, the 30 mil thick film was ground using a Rapid Granulator (R35 Series), fitted with a ½″ mesh filter for controlling the particle size to produce flake used during the dyer sticking tests.

Evaluation of flake sticking during drying was conducted with a specially built canister apparatus, inserted into the center of a standard Conair drying hopper. The Conair dryer hopper used (Model 18054103) was approximately 3 feet tall (height above the cone) and 22 inches inner diameter. The hopper was heated with a CD-100 drying unit (Model D01 H4000300). The removable stainless steel canister insert was 10 inches in diameter and 9 inches tall, and rested on a solid plate welded to the bottom of the dryer, just above the cone and inlet air pipe. The solid plate had a 10 inch diameter thick mesh screen in the center. This setup effectively forced all air flow through only the bottom of the canister insert. To conduct a sticking test, the canister was filled with 6 pounds of test flake, and positioned onto the solid plate inside the drying hopper. In order to simulate a full scale dryer filled with the test flake (6-10 feet tall), a stack of four 25 pound weights were applied to the top of the flake. This was done by welding a 10″ diameter mesh plate (again to permit exiting air flow from the top of the canister) to a narrow rod which extended vertically through the top of the drying hopper. The upper mesh plate was placed in contact with the test flake, and the stack of weights was then applied to the top of the rod, on the outside of the dryer. The motivation for building this unique setup was to adequately represent the experience of flake in a full-scale dryer setup (which would require 500-10,000 pounds of material), while utilizing very small quantities of flake (less than 10 pounds of material). To perform a dryer sticking experiment, the canister was filled with 6 pounds of the test flake. Then, the canister was inserted into the dryer hopper, where the air temperature was set to 300° F. Next, the weights were applied for a two hour time period. Two hours was considered enough time, because it is much greater than the lowest crystallization halftime (30 minutes) of any materials examined. The weights were removed and the canister was pulled from the hopper. After 15 minutes of cooling time, the canister was emptied and flake collected. Flake can be loosely or strongly bonded together. Flake which is highly friable and loosely bound does not tend to cause major concern in a production scale drying setup, versus flake which strongly bonds together. To account for flake friability in the assessment of sticking, the cooled flake was placed in a 300 pound capacity fiber drum and tumbled for two minutes. Following this, the flake was poured through a ½×½ inch wire mesh. Clumps that did not pass through the wire mesh were weighed. The percent clumping was calculated as the weight of clumps divided by the initial 6 pounds of flake times 100.

### Polyesters

Polyester P1 was made on a commercial-scale polyester line with the stated composition in Table 1. The feed material for the TPA residues was DMT and the melt-phase product from the polycondensation reactor was not subject to solid-state polycondensation. The inherent viscosity was measured as indicated above on the amorphous pellet (pellet IhV). The inherent viscosity was also measured after extruding a 30 mil film and then grinding the film into flake as described above (film IhV). The crystallization half-time was measured as indicated above and the melting point temperature was measured by Method 1. The data are summarized in Table 1.

Polyester P2 was made on a commercial-scale polyester line with the stated composition in Table 1. The feed material for the TPA residues was DMT and the melt-phase product from the polycondensation reactor was not subject to solid-state polycondensation. The data are summarized in Table 1.

Polyester P3 was made on a commercial-scale polyester line with the stated composition in Table 1. The feed material for the TPA residues was DMT and pellets from the melt-phase polycondensation reactor had an IhV of 0.72 dL/g. These pellets were then solid-stated in approximately 75 pound batches at 205° C. for approximately 8 hours to produce a crystallized pellet with an IhV of 0.77 dL/g. Neither the melting point temperature nor crystallization half-time were measured on this polyester. The data are summarized in Table 1.

Polyester P4, EASTAR 9921 polyester resin, was obtained commercially from Eastman Chemical Company (Kingsport, Tenn.). The data are summarized in Table 1.

Polyester P5, ASPIRA EN177 polyester resin, was obtained commercially from Eastman Chemical Company (Kingsport, Tenn.). The data are summarized in Table 1.

Polyester P6 was obtained by solid-stating polyester P4 in approximately 75 pound batches at 215° C. for approximately 26 hours to produce a crystallized pellet with an IhV of 0.91 dL/g. Neither the melting point temperature nor crystallization half-time were measures on this polyester. The data are summarized in Table 1.

TABLE 1
Polyester Characterization Data

| | Polyester | | | | | |
|---|---|---|---|---|---|---|
| | P1 | P2 | P3 | P4 | P5 | P6 |
| Mole % TPA | 99.7 | 99.7 | 99.7 | 100 | 99.7 | 100 |
| residues | | | | | | |
| Mole % TMA | 0.3 | 0.3 | 0.3 | 0 | 0.3 | 0 |
| residues | | | | | | |
| Mole % EG | 90.9 | 90.6 | 90.9 | 96.5 | 80 | 96.5 |
| residues | | | | | | |
| Mole % | 9.1 | 9.4 | 9.1 | 3.5 | 20 | 3.5 |
| CHDM | | | | | | |
| residues | | | | | | |
| Pellet IhV | 0.76 | 0.73 | 0.77 | 0.75 | 0.73 | 0.91 |
| (dL/g) | | | | | | |
| Film IhV | 0.74 | 0.72 | (1) | 0.66 | 0.70 | (1) |
| (dL/g) | | | | | | |
| Crystallization | 2 | 2 | NM | 0.8 | 20 | NM |
| half-time (min) | | | | | | |
| Method 1 | 225 | 225 | NM | 241 | 202 | NM |
| Tₘ (° C.) | | | | | | |
| Melt phase | Y | Y | N | Y | Y | N |
| production | | | | | | |

(1) No films were made out of Polyester P3 or P6

### Dryer Sticking Test

The details of the dryer-canister set-up and operation are described above. For Experiment E1, Polyester P1 was blended at a 50 weight percent level with post-consumer recycled (PCR) PET flake obtained from Pure Tech Plastics (91 East Carmans Road, East Farmingdale, N.Y.). The dryer sticking test was conducted at 150° C., and the percent (%) clumping denotes the fraction of the 6 pound sample that was caught on a ½×½ inch wire mesh screen. The experiment was repeated with Polyester P4 (C2) and Polyester P5 (C3). The results are summarized in Table 2.

TABLE 2
Dryer Sticking

| | | Weight % |
|---|---|---|
| | Polyester | Clumping |
| E1 | P1 | 4 |
| C2 | P4 | 10 |
| C3 | P5 | 57 |

Polyester P1 showed the lowest weight percent clumping. It is unexpected that Polyester P1 shows a lower percent clumping than Polyester P4 because Polyester P1 has a longer crystallization half-time than Polyester P4, 2 minutes for P1 as opposed to 0.8 minutes for P4. Theamount of time for two particles of flake to adhere to one another and clump is expected to be proportional to the time it takes for the amorphous flake portion to crystallize. Nevertheless, the unique composition of Polyester P1 exhibits the benefit of a smaller weight percent clumping when blended with PCR PET than Polyesters P4 and P5.

### Co-Polyester and PET Melting Point Temperature Test

Table 3 reports the measured melting point temperatures (Method 2) of blends made by the protocol listed below, executed on the named example and corresponding control PET at 0 to 50 wt % loadings. In each case, the following general procedure was followed, as listed in the CGD:

1) Polyester P1 or P5 and various control PET materials were independently dried, extruded, re-pelletized, and crystallized. Extrusion processing was conducted according to typical PET processing conditions (240-280° C. barrel temperature settings). Crystallization was conducted at approximately 160° C.

2) Pellet-pellet blends were formed by combining the re-pelletized Polyester P1 or Polyester P5 and the re-pelletized control PET resins from Step 1. The blends were dried at 160° C. for at least 4 hours. The relative amount of each resin in each blend is given in Table 3.

3) The dry blends from Step 2 were extruded, re-pelletized, and crystallized. Extrusion processing was conducted according to typical PET processing conditions (240-280° C. barrel temperature settings). Crystallization was conducted at approximately 160° C.

4) The crystallized blends from Step 3 were solid-stated (195-215° C.) until a nominal 0.80 intrinsic viscosity (ItV) was obtained.

5) DSC melting point measurements were conducted on the solid-stated pelletized blends from Step 4, according to Method 2 (at 10° C./min, on the second heat scan following annealing for 2 minutes at 280° C.).

The control PET resins are listed in Table 3 and were each commercially available resins: POLYCLEAR PET 1101 (“Invista 1101”), a carbonated soft drink PET grade resin (2.5 mole % IPA) having a pellet ItV of 0.84 dL/g available from Invista (Charlotte, N.C.); Pure Tech PCR Flake, a post-consumer recycle (PCR) PET having a pellet ItV of 0.80 dL/g available from Pure Tech Plastics (East Farmingdale, N.Y.); Eastman 9921 PET resin (3.5 mole % CHDM), having a pellet ItV of 0.80 dL/g and Eastman CB12 PET resin (2.6 mole % IPA) having a pellet ItV of 0.82 dL/g, both from Eastman Chemical Company (Kingsport, Tenn.); and DAK Laser+44A, a water bottle PET resin with a pellet ItV of 0.75 dL/g, available from DAK (Charlotte, N.C.). The Pure Tech PCR flake was expected to be variable in composition as it was derived from many unknown PET constituents in the market place. A portion of the Pure Tech PCR flake was extruded under PET processing conditions and found to have 2.5 mole % IPA. The composition of the DAK Laser+44A was not measured. Of these control PET resins, the Invista 1101, DAK Laser+44A, and Eastman CB12 resins are named PET Control Resins listed in the CGD. Eastman 9921 resin is not a PET Recycle Standard resin, as defined herein above, since it has nominally 3.5 mole % CHDM as the modifier instead of the PET Recycle Standard resin required 0.5 to 4 mole % IPA as the modifier. For completeness of disclosure, results of the melting point temperature tests are reported for each blend made of a Control PET and Polyester P1 or Polyester P5.

TABLE 3
Melting Point Temperature

| | | | PET | | Melting |
|---|---|---|---|---|---|
| | | | Standard | | Point |
| Exam- | Poly- | | Resin | Weight % | Temp |
| ple | ester | Control PET | (Y/N) | Polyester | (° C.) |
| C4 | NA | Invista 1101 | Y | 0 | 244 |
| C5 | P1 | Invista 1101 | Y | 25 | 241 |
| E6 | P1 | Invista 1101 | Y | 50 | 237 |
| C7 | P5 | Invista 1101 | Y | 10 | 243 (1) |
| C8 | P5 | Invista 1101 | Y | 25 | 240 (1) |
| C9 | P5 | Invista 1101 | Y | 50 | 233 |
| C10 | NA | Pure Tech PCR | Y | 0 | 244 |
| | | Flake | | | |
| E11 | P1 | Pure Tech PCR | Y | 50 | 237 |
| | | Flake | | | |
| C12 | NA | Eastman 9921 | N | 0 | 238 (2) |
| C13 | P1 | Eastman 9921 | N | 50 | 229 (2) |
| C14 | P1 | Eastman 9921 | N | 50 | 234 |
| C15 | P5 | Eastman 9921 | N | 50 | 227 (2) |
| C16 | NA | DAK Laser + 44A | Y | 0 | 248 |
| C17 | P5 | DAK Laser + 44A | Y | 10 | 246 |
| C18 | P5 | DAK Laser + 44A | Y | 25 | 240 |
| C19 | NA | Eastman CB12 | Y | 0 | 244 |
| C20 | P5 | Eastman CB12 | Y | 12 | 240 |
| C21 | P5 | Eastman CB12 | Y | 25 | 237 |

(1) Blend pellets from Step 4 were molded into 3 mm plaques and crystallized. The DSC samples were cut from the molded plaques; all other Tₘ measurements were performed on the blend pellets from Step 4.
(2) DSC scan rate was 20° C./min; all other DSC scan rates were 10° C./min.

The APR 3.1 Melting Point Test in the CDG lists the critical value range for the blend melting point temperature as 235-255° C., to be acceptable. The blend of Invista 1101 with 50 weight percent of Polyester P1 passes the CDG Melting Point Test with a Tₘ of 237° C. The blend of Invista 1101 with 50 weight percent of Polyester P5 fails the CDG Melting Point Test with a Tₘ of 233° C. which is outside the critical value range.

### Extrusion Processing—Melt Quality

The purpose of this experiment is to illustrate the processing advantages of Polyester P1, due to it being melt-phase produced (amorphous pellet) versus solid-state produced (crystallized pellet). Note that the composition and target IhV are the same for Polyester P1 and Polyester P3, the difference is melt-phase (P1) versus solid-state (P3) production methods. The plastication machine used to evaluate melt quality was a Davis-Standard DS-25 2.5 inch extruder with a three-zone air-cooled barrel. The screw was a standard barrier type screw common for copolyester processing. The die had a streamlined transition section, which entered a plate with a flat, thin entrance and exit. The die exit consisted of a slot 3″ wide with a gap thickness of 0.060″ and a 0.60″ land length. Note that the minimum barrel settings were bound by the melting point temperature of the formulation. Melt temperatures reported were measured with a hand-held probe, inserted into the polymer stream, exiting the die.

Example E22 was performed by extruding Polyester P1 at a 7.5 revolutions per minute (RPM) speed, corresponding to a residence time of 8.2 minutes and an output of 35 lb./hr., with the metering zone temperature set to 225° C. Polyester P1 was dried at 150° F. for 6 hours prior to extrusion. The extrudate melt temperature was measured as 231° C. The extrudate was visually checked for gels and/or un-melts. The extrudate for E22 showed no gels or un-melts. For Examples E23-E27, the extrusion was repeated using Polyester P1 at different RPM and metering temperature set points as shown in Table 4. For Comparative Examples C28-C33, the extrusion was repeated using Polyester P3 at different RPM and metering zone temperature set points. Polyester P3 was dried at 280° F. for 6 hours. The higher drying temperature for Polyester P3 versus P1 is because the solid-stated, crystalline P3 required hotter drying conditions to remove moisture. An RPM of 15 corresponds to a residence time of 4.1 minutes and an output rate of 62 lb./hr. The data are summarized in Table 4.

TABLE 4
Extrusion Processing Data

| | | | Metering | Extrudate | Gels/un- |
|---|---|---|---|---|---|
| | | | Zone Temp | Melt Temp | melts |
| | Polyester | RPM | (° C.) | (° C.) | observed? |
| E22 | P1 | 7.5 | 225 | 231 | No |
| E23 | P1 | 7.5 | 235 | 241 | No |
| E24 | P1 | 7.5 | 250 | 252 | No |
| E25 | P1 | 15 | 225 | 233 | No |
| E26 | P1 | 15 | 235 | 243 | No |
| E27 | P1 | 15 | 250 | 253 | No |
| C28 | P3 | 7.5 | 225 | 228 | Yes |
| C29 | P3 | 7.5 | 235 | 238 | Yes |
| C30 | P3 | 7.5 | 250 | 245 | Yes |
| C31 | P3 | 15 | 225 | 232 | Yes |
| C32 | P3 | 15 | 235 | 239 | No |
| C33 | P3 | 15 | 250 | 251 | No |

As shown in Table 4, the solid-state formulation requires hotter extrudate melt temperatures before all gels and un-melts are eliminated. For Comparative Examples C28-C30, at 7.5 RPM, no barrel temperature setting was able to produce a high quality melt for Polyester P3 (245° C., was the maximum extrudate melt temperature reached and gels and/or unmelts were observed). Conversely, Examples E22-E24 show that Polyester P1 exhibits a good quality melt stream with no visible gels and/or unmelts at extrudate melt temperatures as low as 231° C. at an RPM of 7.5. At the higher RPM of 15, Polyester P1 shows no visible gels and/or un-melts at extrudate melt temperatures as low as 233° C. whereas Polyester P3 shows gels and/or unmelts at a extrudate melt temperature of 232° C. but does not show gels and/or unmelts at the higher extrudate melt temperature of 239° C. A low extrudate melt temperature is advantageous for EBM and profile extrusion processes, since this enables maximum melt strength and minimal IhV degradation during processing.

### IhV Loss During Extrusion

The purpose of this experiment is to illustrate further, the advantages of processing a formulation with a low melting point temperature. Once again, the Davis-Standard DS-25 2.5 inch extruder described above was utilized to examine degradation during the extrusion process (IhV drop). IhV loss is primarily a function of three variables: moisture level in the pellet, residence time in the extruder (RPM), and the metering zone temperature set point used during extrusion.

Example E34 was performed by extruding Polyester P1 with a moisture content of 125 ppm at a 7.5 RPM speed with the metering zone temperature set to 235° C. Polyester P1 pellets were dried at 150° F. to a moisture content of approximately 100 ppm (well-dried pellets) and were blended with undried pellets having a moisture content of approximately 1000 ppm to give an overall moisture content of 125 ppm. The extrudate melt temperature of Polyester P1 was measured as 238° C. The drop in IhV is the difference in the pellet IhV minus the IhV of the extrudate, and for E34 the drop in IhV was 0.02 dL/g. The Examples E35-E39 illustrate the IhV loss of Polyester P1 under the conditions given in Table 5. The moisture content was obtained by varying the relative amount of well-dried and undried pellets to get the moisture content listed in Table 5. Comparative Example C40 was performed by extruding Polyester P6 with a moisture content of 25 ppm at a 7.5 RPM speed with the metering zone temperature set to 265° C. Polyester P6, which was solid-stated and crystalline, was dried at 280° F. until a moisture content of 25 ppm was reached. The drop in IhV was 0.22 dL/g. The Comparative Examples, C41-C42, illustrate the IhV loss of Polyester P6 under the conditions given in Table 5.

TABLE 5
IhV loss during extrusion

| | | | | Metering | Melt | |
|---|---|---|---|---|---|---|
| | | Moisture | | zone | Temp | IhV Drop |
| | Polyester | (ppm) | RPM | temp (° C.) | (° C.) | (dL/g) |
| E34 | P1 | 125 | 7.5 | 235 | 238 | 0.02 |
| E35 | P1 | 125 | 15 | 235 | 239 | 0.02 |
| E36 | P1 | 125 | 25 | 235 | 246 | 0.01 |
| E37 | P1 | 500 | 7.5 | 235 | 238 | 0.06 |
| E38 | P1 | 500 | 15 | 235 | 241 | 0.05 |
| E39 | P1 | 500 | 25 | 235 | 243 | 0.03 |
| C40 | P6 | 25 | 7.5 | 265 | 266 | 0.22 |
| C41 | P6 | 25 | 15 | 265 | 265 | 0.16 |
| C42 | P6 | 25 | 25 | 265 | 269 | 0.13 |

Polyester P6 is a highly solid-stated PET (0.91 dL/g IhV) which should have suitable melt strength for the EBM or profiles process. In general, an IhV loss of >0.1 dL/g would be considered deleterious to successful EBM processing. As shown above in Comparative Examples C40-C42, even after thorough drying (<50 ppm) Polyester P6 does not appear capable of maintaining a suitably high IhV, necessary for melt strength. By contrast, Polyester P1 shows excellent retention of IhV during extrusion processing, even when processed wet (500 ppm). It should be mentioned that lowering the metering zone temperatures to 245° C. (where IhV loss may be lessened) was attempted for Polyester P6. At this point, gels and un-melts became apparent indicating the zone temperature set points must be set >245° C. In order to reduce gels and/or unmelts, a solid-stated formulation requires EBM processing at temperature conditions higher than does the same composition which has been produced in the melt-phase.

### Extrusion Blow Molding (EBM)

In Example E43, Polyester P1 was processed using an 80 mm Bekum H-121 continuous extrusion blow molding machine fitted with a barrier screw (Xaloy Fusion). The die bushing and mandrel pin tooling were sized at 48 mm and 44.5 mm (outer diameter), respectively. Polyester P1 was dried for 12 hours at 65° C. prior to extrusion. The screw rotated at 10-12 RPM's and the barrel (5 zones) and die head tooling temperatures were controlled between 230 and 260° C. The mold temperatures were maintained at 50° C. Polyester P1 was blown into 1.75 liter handleware containers (80 g containers). The processing temperature was varied from 245° C. to 260° C. Bottles were made consistently at all temperatures in this temperature range. No melt fracture was observed, and the IhV drop during processing was <0.03 dL/g.

In Example E44, Polyester P2 was processed using an 80 mm Bekum H-121 continuous extrusion blow molding machine fitted with a barrier screw (Xaloy Fusion). The die bushing and mandrel pin tooling were sized at 48 mm and 44.5 mm (outer diameter), respectively. The Polyester P2 was dried for 12 hours at 65° C. prior to extrusion. Compositions with sufficient melt strength were blown into 1.75 liter handleware containers. The screw rotated at 10-12 RPM's and the barrel (5 zones) and die head tooling temperatures were controlled between 230 and 260° C. The mold temperatures were maintained at 50° C. Polyester P2 was blown into 1.75 liter handleware containers (80 g containers). The processing temperature was varied from 245° C. to 260° C. Bottles were produced, but stability of the process was challenged at the higher temperatures. No melt fracture was observed.

In prophetic Comparative Example C45, Polyester P3 does not make acceptable bottles because of gels present at the required processing temperature.

In prophetic Comparative Example C46, Polyester P4 does not make acceptable bottles because of low melt strength at the required processing temperature.

In prophetic Comparative Example C47, Polyester P5 makes acceptable bottles over the 220° C. to 240° C. processing window. No melt fracture is observed. Polyester P5, however failed the APR Melting Point Test requirement. See, Comparative Example C9.

In prophetic Comparative Example C48, Polyester P6 does not make acceptable bottles because of low melt strength due to high IhV drop at the required processing temperature.

The invention has been described in detail with reference to the embodiments disclosed herein, but it will be understood that variations and modifications can be effected within the spirit and scope of the invention.

1. An extrusion blow molded article comprising at least one polyester which comprises:
(a) a dicarboxylic acid component comprising:
i) 90 to 100 mole % of terephthalic acid residues;
(ii) 0 to 10 mole % of aromatic and/or aliphatic dicarboxylic acid residues having up to 20 carbon atoms; and
(b) a glycol component comprising:
(i) 88 to 93 mole % of ethylene glycol residues; and
(ii) 7 to 12 mole % of 1,4-cyclohexanedimethanol residues;
(iii) 2 mole % or less of diethylene glycol residues; and
(c) at least one branching agent in the amount ranging from 0.1 to 1.0 mole % based on the total moles of glycol residues if said branching agent has hydroxyl substituents and otherwise based on the total moles of acid residues;
wherein the total mole % of the acid residues is 100 mole %, and the total mole % of the glycol residues is 100 mole %;
wherein the inherent viscosity (IhV) of said polyester ranges from 0.7 to 1.1 dL/g as determined in 60/40 (wt/wt) phenol/tetrachloroethane at a concentration of 0.25 g/50 nil at 25° C.; and
wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

2. The article of claim 1 wherein said branching agent is present in the amount ranging from 0.1 to 0.6 mole %.

3. The article of claim 1 wherein said polyester comprises 8 to 10 mole % of 1,4-cyclohexanedimethanol residues.

4. The article of claim 1 wherein the inherent viscosity (IhV) of said polyester ranges from 0.7 to 0.9 dL/g.

5. The article of claim 1 wherein the melting point temperature (Tₘ) of said blend ranges from 235 to 245° C.

6. The article of claim 1 wherein said polyester is not subjected to solid-state polycondensation.

7. The article of claim 1 which comprises at least one additive chosen from colorants, mold release agents, phosphorus compounds, plasticizers, nucleating agents, UV stabilizers, glass fiber, carbon fiber, fillers, impact modifiers, or a mixture thereof.

8. The article of claim 1 which is a container.

9. The article of claim 1 which is a bottle.

10. An extrusion blow molded article comprising at least one polyester which comprises:
(a) a dicarboxylic acid component comprising:
(i) 90 to 100 mole % of terephthalic acid residues;
(ii) 0 to 10 mole % of aromatic and/or aliphatic dicarboxylic acid residues having up to 20 carbon atoms; and
(b) a glycol component comprising:
(i) 88 to 93 mole % of ethylene glycol residues; and
(ii) 7 to 12 mole % of 1,4-cyclohexanedimethanol residues; and
(c) at least one branching agent in the amount of 0.1 to 1.0 mole % based on the total moles of glycol residues if said branching agent has hydroxyl substituents and otherwise based on the total moles of acid residues;
wherein the total mole % of the acid residues is 100 mole %, and the total mole % of the glycol residues is 100 mole %;
wherein the inherent viscosity (IhV) of said polyester ranges from 0.7 to less than 0.8 dL/g as determined in 60/40 (wt/wt) phenol/tetrachloroethane at a concentration of 0.25 g/50 ml at 25° C.;
wherein said article has a sidewall haze value of less than 15% as measured by ASTM D1003, Method A; and
wherein the melting point temperature (Tₘ) of a blend of 50 weight % of said polyester with 50 weight % of a PET Recycle Standard ranges from 230 to 245° C. as determined by ASTM D3418 at a scan rate of 10° C./min on a sample prepared using a Recycle Sample Prep Protocol.

11. The article of claim 10 wherein said branching agent is present in the amount ranging from 0.1 to 0.6 mole %.

12. The article of claim 10 wherein said polyester comprises 8 to 10 mole % of 1,4-cyclohexanedimethanol residues.

13. The article of claim 10 wherein the inherent viscosity (IhV) of said polyester ranges from 0.7 to 0.78 dL/g.

14. The article of claim 10 wherein the melting point temperature (Tₘ) of said blend ranges from 235 to 245° C.

15. The article of claim 10 wherein said polyester is not subjected to solid-state polycondensation.

16. The article of claim 10 which comprises at least one additive chosen from colorants, mold release agents, phosphorus compounds, plasticizers, nucleating agents, UV stabilizers, glass fiber, carbon fiber, fillers, impact modifiers, or a mixture thereof.

17. The article of claim 10 which is a container.

18. The article of claim 10 which is a bottle.

19. An extrusion blow molding process comprising: extrusion blow molding a polyester at a shear rate of at least 450 sec⁻¹ to thereby form an extrusion blow molded article; wherein said extrusion blow molded article has a sidewall haze of less than 15% as measured by ASTM D 1003, Method A; wherein said polyester comprises a dicarboxylic acid component and a glycol component, wherein said dicarboxylic acid component comprises at least 90 mole % terephthalic acid residues and said glycol component comprises 88 to 93 mole % of ethylene glycol residues, 7 to 12 mole % 1,4-cyclohexanedimethanol residues, and 2 mole % or less of diethylene glycol residues; and wherein the melting point temperature (Tₘ) of a blend of 50 weight % of said polyester with 50 weight°/0 of a PET Recycle Standard ranges from 230 to 245° C. as determined by ASTM D3418 at a scan rate of 10° C./min on a sample prepared using a Recycle Sample Prep Protocol.

20. The extrusion blow molding process of claim 19 wherein said extrusion blow molding is carried out at a shear rate of at least 550 sec⁻¹.

21. The extrusion blow molding process of claim 19 wherein said extrusion blow molded article has a sidewall haze of less than 10%.

22. The extrusion blow molding process of claim 19 wherein said extrusion blow molding is carried out at a shear rate of at least 650 sec⁻¹.

23. The extrusion blow molding process of claim 22 wherein said extrusion blow molded article has a sidewall haze of less than 5%.

24. The extrusion blow molding process of claim 19 wherein said extrusion blow molded article is a container or bottle having an internal volume of at least 1 liter.

25. The extrusion blow molding process of claim 24 wherein said extrusion blow molded article has an internal volume of at least 2 liters.

26. The extrusion blow molding process of claim 19 wherein said extrusion blow molded article is a container or bottle having a through-handle.

27. The extrusion blow molding process of claim 19 wherein said glycol component comprises 8 to 10 mole % of 1,4-cyclohexanedimethanol residues.

28. The extrusion blow molding process of claim 19 wherein said glycol component comprises at least 90 mole % of ethylene glycol residues.

29. The extrusion blow molding process of claim 19 wherein said dicarboxylic acid component comprises at least 95 mole % of terephthalic acid residues.

30. The extrusion blow molding process of claim 19 wherein said polyester further comprises a branching agent in an amount ranging from 0.1 to 1.0 mole % based on the total moles of glycol residues if said branching agent has hydroxyl substituents and otherwise based on the total moles of acid residues.

31. The extrusion blow molding process of claim 30 wherein said branching agent is selected from one or more of the group consisting of trimellitic acid, trimellitic anhydride, trimethylolpropane, pentaerythritol, and trimethylolethane.

32. The extrusion blow molding process of claim 19 wherein said polyester is not subjected to solid-state polycondensation.

33. The extrusion blow molding process of claim 19 wherein the inherent viscosity (IhV) of said polyester ranges from 0.7 to 0.9 dUg as determined in 60/40 (wt/wt) phenol/tetrachloroethane at a concentration of 0.25 g/50 ml at 25° C.

34. The article of claim 1 wherein the inherent viscosity (IhV) of said polyester ranges from 0.7 to less than 0.8 dL/g.

35. The article of claim 1 wherein the inherent viscosity (IhV) of said polyester ranges from 0.7 to 0.78 dL/g.
